(19) United States
(12) Patent Application Publication
(10) Pub. No.: US 2014/0281587 A1
(43) Pub. Date: Sep. 18, 2014

(54) SYSTEMS, METHODS AND APPARATUSES FOR USING A SECURE NON-VOLATILE STORAGE WITH A COMPUTER PROCESSOR

(71) Applicant: OLogN Technologies AG, Triesen/FL (LI)

(72) Inventor: Sergey IGNATCHENKO, Innsbruck (AT)

(73) Assignee: OLogN Technologies AG, Triesen/FL (LI)

(21) Appl. No.: 14/206,992

(22) Filed: Mar. 12, 2014

Related U.S. Application Data
(60) Provisional application No. 61/785,388, filed on Mar. 14, 2013.

(51) Int. Cl. G06F 21/60

(52) U.S. Cl. CPC G06F 21/602
USPC 713/193

(57) ABSTRACT

The systems, methods and apparatuses described herein provide a system for accessing data stored securely external of a computer processor. In one aspect, the computer processor may comprise a central processing unit (CPU) and a memory controller. The memory controller may comprise a storage to store a key, a first set of circuitry and a security module. The first set of circuitry may be configured to receive a request for a piece of data from the CPU, determine that the requested piece of data needs to be read from an external storage stored in a secured format and read the piece of data from the external storage in the secured format. The security module may be configured to perform at least one of authentication and decryption on the piece of data in the secured format using the key stored in the storage.

### RELATED APPLICATIONS

This application claims priority to U.S. Provisional Application No. 61/785,388, filed Mar. 14, 2013, entitled “Systems, Methods and Apparatuses for Using a Secure Non-volatile Storage with A Computer Processor,” the content of which is incorporated herein by reference in its entirety.

### FIELD OF THE DISCLOSURE

The systems, methods and apparatuses described herein relate to secure storage of data in a secure non-volatile storage and a computer processor using the data securely stored in such a secure non-volatile storage.

### BACKGROUND

A computer processor normally uses a variety of storage for data (e.g., code, or data operated on by code). For example, in addition to on-chip cache memory (e.g., L1, L2 caches), a modern day computer processor also needs to access the main memory of its host computer system for computing needs. Loading data from outside of the computer processor (such as the main memory), however, bears a lot of security risks because the data may be tampered with, or even worse, may be malicious. Thus, for security purposes, sometimes it is desirable for certain data (e.g., security related logic, BIOS) to be tamper protected, read protected, or both.

One existing solution stores the data to be protected on the computer processor chip. This solution, however, is limited by the non-volatile storage space available on the computer chip. Moreover, increasing non-volatile storage space to accommodate more data is generally not practical. Therefore, there is a need in the art for certain data to be securely stored in a non-volatile storage external to a computer processor chip.

### BRIEF DESCRIPTION OF THE DRAWINGS

FIG. 1A is a block diagram of an exemplary system according to the present disclosure.

FIG. 1B is a block diagram showing storage and usage of the data on a non-volatile storage according to the present disclosure.

FIG. 2 is a flow diagram of an exemplary process of preparing a non-volatile storage and a computer processor according to the present disclosure.

FIG. 3 is a flow diagram of an exemplary process of a computer processor using a non-volatile storage according to the present disclosure.

FIG. 4 is a block diagram of an exemplary storage controller according to the present disclosure.

FIG. 5 is a flow diagram of an exemplary process of reading data from a non-volatile storage according to the present disclosure.

FIG. 6 is a block diagram of another exemplary memory controller according to the present disclosure.

FIG. 7 is a flow diagram of another exemplary process of reading data from a non-volatile storage according to the present disclosure.

FIG. 8 is a block diagram of another exemplary system according to the present disclosure.

FIG. 9A is a flow diagram of an exemplary process of storing data on a non-volatile memory according to the present disclosure.

FIG. 9B is a block diagram showing exemplary data structures for performing an update to a non-volatile storage according to the present disclosure.

FIG. 9C is a flow diagram of an exemplary process of applying an update to a non-volatile storage according to the present disclosure.

### DETAILED DESCRIPTION

Certain illustrative aspects of the systems, apparatuses, and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

The present disclosure comprises systems, methods and apparatuses for storing secured data in a non-volatile storage and usage of the secured data by a computer processor, wherein the computer processor may request secured data in a non-sequential manner (e.g., random access). The secured data may be encrypted, authenticated, or both authenticated and encrypted. In one embodiment, the secured data may be encrypted and/or authenticated while being stored to the non-volatile storage. During the operation of the computer processor, the secured data may be read from the non-volatile storage by the computer processor and decrypted/authenticated within the computer processor. Thus, even if an attacker intercepts the data during the transit from the non-volatile storage and/or reads the encrypted data from the non-volatile storage, the security of the data is still not breached.

FIG. 1A shows a block diagram of an exemplary system 100A according to the present disclosure. The exemplary system 100A may be part of a computer system (e.g., several components on a mother board of the hosting computer system) and may comprise a processor 150A, a random access memory (RAM) 195 and a non-volatile storage 192. The processor 150A may comprise one or more cores, which may be referred to as central processing units (CPUs) (e.g., CPU0 112, and CPU1 112A). The CPUs may have caches (e.g., L1 cache, L2 cache, L3 cache). As an non-limiting example shown in FIG. 1A, the CPUs 112 and 112A may each have its own L2 caches (i.e., L2 cache 114 and L2 cache 114A) but share a L3 cache 116. The CPUs may execute instructions and process data. The instructions and data to be processed may be collectively referred to as data herein. The data may be fetched from outside of the processor 150A and stored in the caches when being executed or operated upon by the CPUs.

The processor 150A may further comprise a memory controller 160, which may comprise an encryption/decryption key 165. The memory controller 160 may be configured to fetch data via an interface 130 from an external storage. Thus, whenever the CPUs need data not available in the caches (e.g., L2 or L3 caches), the memory controller 160 may fetch the needed data for the CPUs from the external storage. The external storage may be any storage outside of the processor 150A that may store data accessible by the processor 150A. For example, as shown in FIG. 1A, the external storage may comprise the random access memory (RAM) 195 and the non-volatile storage 192. In a non-limiting embodiment, the RAM 195 may be the main memory for the computer system hosting the processor 150A. The RAM 195 may comprise any volatile memory modules that may lose the data stored therein when powered off. By way of example and not limitation, the RAM 195 may comprise double data rate synchronous dynamic random-access memory (DDR SDRAM), DDR2 SDRAM, or DDR3 SDRAM, etc.

The non-volatile storage 192 may comprise any non-volatile storage that may preserve the data stored therein even when powered off. Exemplary non-volatile storage 192 may be, but is not limited to, erasable programmable read only memory (EPROM), electrically erasable programmable read only memory (EEPROM), or flash memory. In some embodiments, the data stored on the non-volatile storage 192 may be copied to the RAM 195 to be fetched by the processor 150A. In some other embodiments, the data stored on the non-volatile storage 192 may be fetched by the memory controller 160 directly via an interface (not shown) without first being copied to the RAM 195. The non-volatile storage 192 may store ordinary data in clear text (i.e., neither authentication nor decryption is needed) and/or as secured data (i.e., need authentication and/or decryption).

The key 165 may be one or more encryption and/or decryption keys used for authenticating and/or decrypting fetched data whenever necessary. In some cases, the data fetched from the external storage may be in clear text and does not need authentication. In these cases, the fetched data may be forwarded directly to the CPUs (e.g., cores and/or their caches) without further processing by the memory controller 160. In some other cases, however, the data fetched from the external storage may need to be decrypted (if it's encrypted), authenticated, or both. The data that need to be decrypted and/or authenticated may be referred to as secured data. In those cases, the memory controller 160 may use the key 165 to decrypt the fetched data, authenticate the fetched data, or decrypt and authenticate the decrypted data. In one non-limiting embodiment, the key 165 may be one or more of a symmetric key, or a private or public key of a public/private key pair. The key 165 may be stored in read-only memory of the processor 150A and may not be exposed outside of the processor 150A. For example, the key 165 may be implemented in hardware as a part of the controller 160. The decryption and authentication process will be described in more detail below.

In one or more embodiments, the memory controller 160 may be packaged within the same physical enclosure as other components of the processor 150A. For example, the memory controller 160 may be fabricated on the same silicon chip as the CPUs and caches. In one non-limiting embodiment, the physical enclosure may be tamper resistant, or at least tamper evident. The physical enclosure may be referred to as a chip (regardless of whether all components of the chip may be on a single semiconductor wafer or multiple semiconductor wafers interconnected).

FIG. 1B is a block diagram showing exemplary storage and usage of data on the non-volatile storage 192 according to the present disclosure. As shown in FIG. 1B, data to be stored in the non-volatile storage 192 may be in units of data segments. One data segment 105 may be shown as a representative but there may be multiple such data segments 105 for the data to be stored. In one non-limiting embodiment, each of the data segments 105 may correspond to one (or more) cache lines of the processor 150A. When data needs to be stored in the non-volatile storage 192, the data segment 105 may be encrypted into an encrypted data segment 110 and an authentication value 115 may also be generated and stored. The encryption of the data segment 105 and generation of the authentication value 115 may use various encryption and authentication algorithms known in the art or developed in the future, some exemplary implementations will be described in detail below. In some cases, the data to be stored does not need to be encrypted but needs to be authenticated when used. In these cases, the authentication value 115 may be generated but the encrypted data segment 110 may be a duplicate of the data segment 105. In both authentication only and encryption and authentication situations, when the stored data is read from the non-volatile storage to be used by a processor (e.g., the processor 150A), an authentication value may be generated during a decryption (if the data is encrypted) and verification process. In one non-limiting embodiment, the generated authentication value may be compared to the stored authentication value 115, which may also be read into the memory controller 160 with the encrypted data segment 110.

In one or more embodiments, the data segment 105 and the encrypted data segment 110 may have the same length in number of bits. Because the authentication value 115 may be stored with the encrypted data segment 110, a storage overhead may exist. In many cases, recalculating addresses by the memory controller 160 may be needed. In one non-limiting embodiment, the allocated address space for each data segment to be stored may be doubled to accommodate the overhead of authentication values. That is, each encrypted data segment 110 and the authentication value 115 may take twice as much address space as the original data segment 105. The double address space approach is merely one exemplary approach and other suitable configurations may be used in addition to or in place of the double address space approach.

In one non-limiting embodiment, the encryption/validation scheme may be implemented using the Counter with cipher block chaining message authentication code (CBC-MAC) (CCM) authenticated encryption algorithm. CCM is defined in Internet Engineering Task Force (IETF) Request for Comments (RFC) 3610, which is incorporated by reference herein in its entirety. The CCM algorithm determines a number M for the number of octets in the authentication field and a number L for the number of octets for the length of the data to be encrypted. For example, the non-volatile storage 192 may have cache lines of 64 bytes and each data segment 105 may be stored in an individual cache line, then each data segment 105 may be encrypted using the CCM algorithm individually with L=2 and M=16. The CCM algorithm with L=2 and M=16 may produce 64 encrypted bytes for the encrypted data segment 110 and 16 bytes of the authentication value for the authentication value 115. Thus, during a read operation of a processor (e.g., the processor 150A), the memory controller 160 may need to read more data chunks for secured data (including both the encrypted data segment 110 and the authentication value 115) than reading an ordinary unsecured cache line (e.g., the data segment 105 alone). For example, if the memory interface 130 is a 64-bit DDR-3 interface, the memory controller 160 may need to read (and subsequently validate) 10 64-bit DDR-3 data chunks (for a secured data cache line) instead of just 8 64-bit DDR-3 data chunks (for an ordinary cache line). It should be noted that the parameters stated above (e.g., L, M, 64-byte cache line, DDR-3 data chunks), are merely exemplary, and many other sets of parameters may be used (for example, in some embodiments, M may be restricted to 8, reducing, but not eliminating, storage overhead to 8 bytes). Exemplary processes to generate the content to be written to the non-volatile storage 192 and to use the data from the non-volatile storage 192 will be described in detail below. Other encryption/validation schemas may also be used (for example EAX or GCM, which are described in detail below).

FIG. 2 shows an exemplary process 200 of preparing a non-volatile storage and a computer processor according to the present disclosure. At block 205, an encryption key may be generated. For example, a trusted party may randomly generate an encryption key to be used for encrypting the data to be stored in the non-volatile storage 192. The trusted party may be a manufacturer of the processor 150A, a manufacturer of the non-volatile storage 192, or any third party trusted by the manufacturers of the processor 150A and non-volatile storage 192. Depending on the encryption algorithm to be used for the data to be stored in the non-volatile storage 192, the encryption key may be a symmetric key for symmetric encryption or a pair of public and private keys for asymmetric encryption. It should be noted that in some embodiments, the non-volatile storage 192 and processor 150A may be manufactured by a common manufacturer.

At block 210, the generated encryption key may be stored inside the computer processor 150A (e.g., as the key 165). If the data encryption is symmetric encryption, the generated key is a symmetric key and this symmetric key may be stored in the computer processor 150A. If the data encryption is asymmetric encryption, the private key may be stored in the processor 150A if the public key is used for encryption, or alternatively, the public key may be stored in the processor 150A if the private key is used for encryption.

In one or more embodiments, the generated key may be stored within the processor 150A in a manner that is the same or similar to storing a unique processor identifier (for example, as the Processor Serial Number used in INTEL Pentium III® processors). However, as described below in detail, this stored key should be protected against outside access and should not be exposed outside of the processor 150A, contrary to the treatment of the unique processor identifier. It should be noted that, unlike the Processor Serial Number, storing the generated encryption key in a manner described in the present disclosure does not create privacy issues associated with Processor Serial Number.

In other embodiments, the generated encryption key may be stored within a non-volatile memory (for example, EPROM, or EEPROM, or flash, or battery-backed static RAM) residing within the processor 150A.

At block 215, the exemplary process 200 may secure the data to be stored in the non-volatile storage 192 using the generated encryption key. As described above, the generated encryption key may be a symmetric key or a pair of asymmetric keys. Thus, in one embodiment, if the secured date is encrypted, the encryption may be symmetric using a symmetric key or asymmetric using either a public or private key depending on the algorithms selected. In another embodiment, the secured data may be stored in the non-volatile storage 192 in an unencrypted format (e.g., clear text) but with an authentication. It should be noted that, as the encryption key is unique for each of manufactured processors 150A, the secured data is also unique for each of manufactured processors 150A. It should be further noted that in different embodiments, the blocks 210 and 215 may be executed in parallel, interleaved, or one ahead of another in no particular order.

In some embodiments, block 215 may be performed by the same production line that produces the processor 150A (or that performs block 210).

Then at block 220, the generated key may be erased from any temporary storage. It should be noted that any storage used for generation and transferring of the key may be deemed as temporary storage. Thus, the key may be erased from the memory of the computer systems where it is generated, erased from the medium used for transition (the non-transitory medium may be physically destroyed), and/or erased from the memory of the computer system that may have performed the encryption in block 215. In one or more embodiments, erasing the generated key from any temporary storage may ensure that no other data may be encrypted using such key and security of the encrypted data may be enhanced.

At block 225, an association between the processor 150A and the secured data generated at block 215 may be formed. In one non-limiting embodiment, a processor serial number of the processor 150A may be associated with the secured data. For example, an entry in a database (not shown) may be created, containing both secured data for specific processor 150A, and processor serial number of the processor 150A.

At block 227, the exemplary process 200 may store the secured data (produced in block 215) in the non-volatile storage 192. It should be noted that, as the data is already secured, this is not a security-sensitive operation, meaning that there is no need to protect the secured data while it is in transit, nor after it is written to the non-volatile storage 192. In addition, as a part of block 227, the non-volatile storage 192 with the stored secured data may be associated with a specific processor 150A (for example, the non-volatile storage 192 may have a label with the identifier of the processor with which it may be used).

Then at block 230, the processor 150A and the associated non-volatile storage 192 may be released to customers.

Data stored in the non-volatile storage 192 may be accessible by any device that can read from the non-volatile storage 192 or read from the RAM 195 if the data is copied to the RAM 195. However, decryption and/or authentication of the secured data may occur only inside the associated processor 150A. FIG. 3 shows an exemplary process 300 that may be implemented by an embodiment of the memory controller 160 according to the present disclosure to implement decryption and/or authentication.

The exemplary process 300 may start at block 305, at which a request for data from a CPU may be received by the memory controller 160. For example, a CPU (e.g., CPU0 112) may request data not available in the caches (e.g., L2 or L3 caches) and thus, a data request may be passed to the memory controller 160 to fetch the requested data from the external storage, such as the main memory (e.g., RAM 195). Then at block 310, the process 300 may determine whether the requested data needs to be read in a secured format. In one non-limiting embodiment, the memory controller 160 may need to determine whether the requested data is non-encrypted data and does not need authentication (i.e., ordinary data). The determination may be made by, for example, comparing an address of the requested data with a predefined table of the address ranges which may be reserved for secured data (e.g., data that is encrypted/verified). If the requested data is ordinary data, the memory controller 160 may fetch the ordinary data via the interface 130 at block 312 and return the fetched data to the requester without further processing, and the exemplary process 300 may end. However, if the requested data is secured data, either in the RAM 195 or that needs to be read directly from the non-volatile storage 192, the memory controller 160 may continue with the exemplary process 300. In some embodiments, one of the address ranges in the predefined table may include an address that the CPU should use as the starting point when it begins execution after a CPU reset.

Then, at block 315, the secured data may be read from the non-volatile storage. As described above, the memory controller 160 may read memory segment(s) either directly from the non-volatile storage 192, or read from the RAM 195 that may contain the secured data pre-fetched from the non-volatile storage 192. At block 320, the secured data read into the memory controller 160 may be decrypted and authenticated if necessary (i.e., an authentication value 115 for each of data segments 105 may be verified). It should be noted that if the secured data coming into the processor 150A may be initially encrypted, the data decryption may occur only inside the processor 150A. Moreover, as described above, there is no copy of the key 165 available outside the processor 150A. Therefore, interception of the encrypted data in its unencrypted form outside of the processor 150A may be impossible.

At the decision block 325, whether the authentication is successful may be determined. If the check is successful, the exemplary process 300 may proceed to block 330, at which the decrypted data or authenticated clear text data may be forwarded to the requesting CPU. The CPU may go on with processing of the fetched data. It should be noted that if the secured data is validated successfully inside the processor 150A, the secured data may have been created with the key 165 (e.g., during the process 200), and therefore this data may be valid data trustworthy to the processor 150A.

If, at block 325, the authentication fails, the exemplary process 300 may proceed to block 335, at which the failure may be reported (e.g., to the CPU requesting the data or other monitoring components of the processor 150A). In some embodiments, the processor 150A may additionally be brought to a special state which can be reset only after some time—e.g., 1 second—and only via a full CPU reset.

FIG. 4 is a block diagram of an exemplary memory controller 160A according to the present disclosure. The memory controller 160A may be an embodiment of the memory controller 160. As shown in FIG. 4, in addition to the key 165 as shown in memory controller 160, the memory controller 160A may further comprise an input buffer 432, a decryption engine 430, an authentication engine 435, an authentication buffer 440 and a temporary buffer 445. The memory controller 160A may read in data from the memory interface 130, buffer the received data in the input buffer 432 to obtain predetermined data blocks (depending on the parameters selected for the particular encryption/authentication algorithms), and then forward the predetermined data blocks to the decryption engine 430. The size of the predetermined data blocks may depend at least in part on the parameters selected for the particular encryption/authentication algorithm. By way of example and not limitation, the data may be buffered in the input buffer 432 to obtain 128-bit (i.e., 16 bytes) blocks. The decryption engine 430 may use the key 165 to decrypt the received data and send the decrypted data to both the authentication engine 435 and appropriate portion of the temporary buffer 445 (which may have a size of data segment/cache line of a predetermined number of bytes depending on the parameters selected when storing the data in the non-volatile storage). The authentication engine 430 may use the authentication buffer 440 as will be described in detail below. In some embodiments, when the CCM algorithm is used, the authentication buffer may be 128-bit—or 16 bytes—long, regardless of the value of M.

As described above, in one or more embodiments, the memory controller 160A may be used with the CCM algorithm. FIG. 5 shows an exemplary process 500 of reading data from a non-volatile storage using an embodiment of the memory controller 160A according to the present disclosure. The description below assumes that the key 165 used in the exemplary process 500 may be a symmetric key. Using an asymmetric key 165 for asymmetric decryption is also within the scope of the present disclosure, with necessary changes using techniques known in the art.

At block 560, a request for data may be received from another component of a processor that hosts the memory controller 160A. The request may come, for example, from a CPU such as the CPU0 112 for data at an address ADDR. At block 565, the memory controller 160A may send a request for address ADDR to the memory external to the processor 150A. For example, the request may be sent to the RAM 195 or the non-volatile storage 192 via the memory interface 130. The address ADDR may be the original address requested by the CPU or, as explained in detail below, may be a recalculated address generated by the memory controller 160A.

At block 570, the memory controller 160A may initialize the authentication buffer 440 using the authentication engine 435. According to the CCM specification, a non-empty sequence of complete data blocks denoted B_{—}0, B_{—}1, . . . B_n for some non-negative integer n may be generated from a payload P, an additional authenticated data (AAD) A and a nonce N. The payload P is optional for CCM and is both encrypted and authenticated if present. The AAD A is also optional, but will only be authenticated, but not encrypted, if present. In one non-limiting embodiment, during the initialization of the authentication buffer 440, the nonce N may be calculated from the address ADDR and the data block B_{—}0 may be generated using the nonce N. Then, the data block B_{—}0 may be encrypted with the key 165 and saved to the authentication buffer 440. The encryption may use, in a non-limiting example, the Advanced Encryption Standard (AES) algorithm.

At block 575, a block of data may be received by the memory controller 160A. For example, this block of data may represent one or more data chunks arriving over the memory interface 130 (e.g., one 128-bit block may consist of two 64-bit chunks arriving over the memory interface 130 for DDR-3). At block 580, the received block of data may be sent to the decryption engine 430, which may performs decryption of the incoming block of data. According to the CCM specification, the decryption may be performed by taking the nonce N—derived from the address ADDR as described below, calculating A_i, producing S_i by encrypting A_i with the key 165, and XOR-ing the received block of data with S_i.

At block 585, the memory controller 160A may send the decrypted data from the decryption engine 430 both to an appropriate portion of the temporary buffer 445, and to the authentication engine 435. At block 587, the authentication engine 435 may process the received decrypted block according to the CCM algorithm for authentication. For example, the authentication engine 435 may take stored data from the authentication buffer 440, XOR it with the data coming from the decryption engine 430, encrypt the XOR result with the key 165, and store the encrypted result back to the authentication buffer 440.

At block 590, the exemplary process 500 may determine whether all blocks of the requested data have been received. If not, the blocks 575-587 may need to be repeated until the whole data segment/cache line is processed. For example, if a cache line is 64 bytes, 4 128-bit data blocks may need to be processed. If the whole data segment has been received, the process 500 may proceed to block 592, at which another data chunk may be received, which may represent the authentication value (e.g., the authentication value 115) according to the CCM algorithm. For example, the authentication value data chunk may have a size of M bytes. It should be noted that CCM specifies M to be less than or equal to 16, so the number of bits in the authentication data chunk may be less than or equal to 128.

At block 594, the received authentication data block may be decrypted by the decryption engine 430. For example, the same decryption algorithm as is done in block 580. Then, at block 596, the decrypted authentication value may be verified. For example, the decrypted authentication data block may be sent to the authentication engine 435, which may compare M bytes out of the decrypted authentication data block with the first M bytes stored in the authentication buffer 440. If there is an exact match, the authentication process may be deemed successful, and the data segment from the temporary buffer 445 may be forwarded to the requesting component of the processor 150A. Otherwise, it may be an error.

In one or more embodiments, if there is an error, the memory controller 160A may be configured to try the read operation for a pre-determined number of times (usually between 1 to 3 times). Moreover, the memory controller 160A may be configured to force the processor 150A into a special state if unsuccessful attempts reach the pre-determined number. The special state may be such that the processor 150A will not perform any operations until a full hardware reset is made. In addition, in some embodiments, hardware reset (from the beginning of the reset until the processor 150A starts to operate) may be restricted to a minimum amount of time (such as 0.1 sec or 1 sec). Because brute force attacks are based on fast, successive retries, setting a minimum amount of time for hardware reset may increase the time needed for brute-force attacks, and in some cases may make such attacks impractical.

In one or more embodiments, the nonce to be used to perform the CCM algorithm may be derived from the address ADDR of the data segment requested, for example, the nonce may be equal to the address ADDR of the data segment or may be a one-to-one function of ADDR. This may help protect against attackers that may swap two data segments and enhance overall system security (e.g., by reducing possibilities for differential cryptanalysis).

As described above, storing the authentication value (e.g., the authentication value 115) may incur storage overhead, thus in many practical cases recalculating addresses by the memory controller 160A may be needed. For example, the addresses requested by a CPU of the processor 150A may not match addresses in the non-volatile storage due to storage overhead. As described above, in one embodiment, the address space for the non-volatile storage 192 may be doubled. For example, an ordinary cache line may be 64-bytes long, while the secured data (encrypted and/or authenticated) data may occupy 128 bytes: 64 bytes of encrypted data and 16 bytes of authentication data, and 48 unused bytes. In some embodiments, those unused bytes may be used to store additional information to be added to the nonce. Accordingly, if, for example, an address range from a first address SECURE_BEGIN to a second address SECURE_END is known to require decryption and/or authentication, then the physical memory of the range from a first physical address SECURE_BEGIN2 to a second physical address SECURE_END2 may be reserved. The physical address range may be set to equal to double of the address range, that is, SECURE_END2−SECURE_BEGIN2=2*(SECURE_END−SECURE_BEGIN). Then, when a request for SZ bytes (SZ being an integer number) is received for an address ADDR (where SECURE_BEGIN<=ADDR<SECURE_END), the memory controller 160A may issue a request over the interface 130 for 2*SZ bytes at address SECURE_BEGIN2+(ADDR−SECURE BEGIN)*2. It should be noted that multiplying by 2 in binary arithmetic may be implemented by a simple shift.

It should further be noted that, in some embodiments, instead of using 2*SZ bytes stored for each SZ bytes requested (which causes 2× overhead), other schemas may be used. As an another non-limiting example, in some embodiments, 64+16 bytes may be stored for each 64 bytes requested. In this example, when the memory controller 160A receives a request for 64 bytes at the address ADDR (which may be divisible by 64), it may issue a request over the interface 130 for 64+16 bytes at address SECURE_BEGIN2+(ADDR−SECURE_BEGIN)/64*(64+16). In some embodiments, the division by 64 may be implemented as a shift, and multiplication by 64+16 may be implemented as two shifts and an addition.

It should be noted that although 128-bit-block ciphers (such as AES-128, AES-192, or AES-256) may be used by CCM, the same method can be used with different block sizes after adjustments using mechanisms known in the art. Moreover, it should also be noted that the encryption may be optional. For example, in some embodiments, the CCM algorithm may be used for authentication alone without encryption by treating all data to be stored as AAD A that only needs to be authenticated. In some other embodiments, any existing symmetric-key-based MAC algorithms may be used instead of the CCM algorithm. With that said, encryption may be beneficial in some cases. For example, any sensitive device-specific data (such as a device's private key) that is intended to be stored in such secure non-volatile storage 192 may benefit from the encryption. Further, in some embodiments, only the sensitive parts of data stored on the non-volatile storage 192 may need to be encrypted. For example, based on a pre-defined address table, some addresses may be designated as “ordinary,” some as “authenticate-only,” and some as “authenticate-and-encrypt.” In these embodiments, requests within “ordinary” and “authenticate-and-encrypt” address ranges may be handled as described above, and requests within “authenticate-only” ranges may be handled similar to requests within “authenticate-and-encrypt” ranges, but omitting encryption (while keeping authentication).

It also should be noted that CCM may be one of many possible algorithms to be used according to the present disclosure. In some embodiments, EAX mode, which is another Authenticated Encryption with Associated Data (AEAD) algorithm as an alternative to the CCM mode, may be used instead of the CCM mode; the exemplary process 500 and the memory controller 160A may be changed to implement the EAX mode. The changes necessary to adapt the process 500 to the EAX mode may use techniques known to those skilled in the art. As EAX has the same requirements for nonces as CCM, some embodiments of EAX-based implementations may use the same nonces generation method as were used for CCM, as described above.

In other embodiments, the Galois/Counter Mode of Operation (GCM or GCM mode) may be used according to the present disclosure. GCM is defined in D. McGrew and J. Viega, “The Galois/Counter Mode of Operation (GCM),” Submission to National Institute of Science and Technology (NIST) Modes of Operation Process, Jan. 15, 2004, which is incorporated by reference herein in its entirety and referred to as “[GCM]” hereinafter. FIG. 6 is a block diagram of an exemplary memory controller 160B according to the present disclosure. The memory controller 160B may be another embodiment of the memory controller 160 that implements all features of the memory controller 160 and also has additional features that may be different from the embodiment of the memory controller 160A. In one or more embodiments, the memory controller 160B may be configured to use GCM.

As shown in FIG. 6, the memory controller 160B may comprise the input buffer 432, the temporary buffer 445 and the key 165, which may be the same components as those of the memory controller 160A. In addition, the memory controller 160B may comprise a Galois field (GF) multiplication engine 610, a H storage 620, a counter 622, a comparator 625, an encryption engine 630, an authentication buffer 640 and XOR modules 646 and 648. The H storage 620 may store a value of H as used in the GCM mode. For example, the H storage may store a value of 128 bits. It should be noted that 128 bits may be just an exemplary block size of cipher while ciphers with different blocks sizes (e.g., 192 bits, 256 bits) may be used in various embodiments according to the present disclosure with necessary changes using techniques known to those skilled in the art. The GF multiplication engine 610 may be an engine to provide multiplication in GF(2̂128), that is, multiplication in finite field with 2̂128 elements. The counter 622 may be a storage of number of bits corresponding to the H storage (e.g., 128 bits). The comparator 625, encryption engine 630 and authentication buffer 640 may be used for GCM as described below using the exemplary process 700 shown in FIG. 7.

The exemplary process 700 may be a process implemented by the memory controller 160B to read data encrypted with GCM from a non-volatile storage (e.g., the non-volatile storage 192). The description below assumes that the key 165 used in the exemplary process 500 may be a symmetric key. Using an asymmetric key 165 for asymmetric decryption is also within the scope of the present disclosure, with necessary changes using techniques known in the art. Also, for simplicity, it may be assumed that the AAD A as described in [GCM] is not used in the exemplary process 700. However, as described above with respect to CCM, the whole data segment to be stored in the non-volatile storage 192 may be treated as AAD A if only authentication is needed.

The exemplary process 700 may start at block 760, at which a request for data at an address ADDR may be received. For example, the memory controller 160B may receive the request for data from one of the CPUs (e.g., CPU0 112 or CPU1 112A). At block 765, the memory controller 160B may send a data request for an address ADDR to the external memory via the memory interface 130. The external memory may be a main memory, such as the RAM 195, or other non-volatile storage of the computer system, such as the non-volatile storage 192. Depending on the address space allocation for encrypted/authenticated data, an address recalculation may be needed similar or identical to those described above with respect to the memory controller 160A in CCM. Then at block 770, the memory controller 160B may initialize components for GCM. For example, the authentication buffer 640 may be initialized with zeros, 96 high bits of the counter 622 may be initialized with a nonce generated from the address ADDR (the original or recalculated address as described above with respect to CCM), and 32 low bits of the counter 622 may be initialized with zeros. The nonce may be used as the initialization vector (IV) as defined in [GCM]. In addition, during the initialization operation, a value of H may be calculated by the encryption engine 630 using the key 165 and stored in the H storage 620. It should be noted that the value of H may be constant for one given symmetric key according to GCM, thus it may need to be calculated only once, or even pre-calculated and stored alongside with the key 165 (eliminating the need to calculate it at block 770).

At block 775, a block of data may be received by the memory controller 160B. For example, this block of data may represent one or more of the data chunks arriving over the memory interface 130 (e.g., one 128-bit block may consist of two 64-bit chunks arriving over the memory interface 130 for DDR-3). At block 780, the received block of data may be sent to the encryption engine 630, which may perform decryption of the incoming block of data according to GCM. For example, the incoming block of data may be decrypted by taking the value from the counter 622 and encrypting incoming data using this value and the key 165 as described in [GCM]. In addition, the encryption engine 630 may modify the value of the counter 622 by applying the incrementing function incr( ) as defined in [GCM]. The decrypted data from the encryption engine 630 may be stored within an appropriate portion of temporary buffer 445.

At block 785, the memory controller 160B may process the decrypted data according to the specific encryption and authentication algorithm. For example, according to GCM, the memory controller 160B may XOR the encrypted incoming data from the input buffer 432 with data from the authentication buffer 640 (using the XOR module 648), and send the result to the GF multiplier engine 610. The GF multiplier engine 610 may multiply the XORed data by the value H from the H storage 620 (in GF(2̂128)). The multiplication result may then be stored back into the authentication buffer 640. In addition, the multiplication result may be XORed with the decrypted data (using the XOR module 646) from the encryption engine 630 to generate an input for the comparator 625. In one or more embodiments, the block 785 may be performed in parallel with block 780.

At block 790, the exemplary process 700 may determine whether all blocks of the requested data have been received. If not, the blocks 775-785 may need to be repeated until the whole data segment/cache line is processed. For example, if a cache line is 64 bytes, 4 128-bit data blocks may need to be processed). After all encrypted data chunks for one data segment/cache line may be received. The exemplary process 700 may proceed to block 792, at which, another data chunk representing the authentication value may be received. For example, the received data chunk may be an Authentication Tag according to GCM.

Then, at block 794, an authentication according to the encryption and authentication algorithm may be performed and the memory controller 160B may determine whether the authentication is successful. In one non-limiting embodiment, the authentication may be performed as follows: a) XOR the value from the authentication buffer 640 with a constant representing len(A)∥len(C) as defined in [GCM], wherein len(A) may be 0 (as described above, the AAD field is not used) and len(C) may be equal to the data segment size; b) multiply the XOR result by H (in GF(2̂128) using the GF multiplier engine 610; c) encrypt the value from the counter 622 (with low 32 bits masked to zeros) with the key 165 using the encryption engine 630; d) XOR the result of (b) and (c) (using XOR module 646); e) compare the XOR result of d) with the data in the input buffer 432 using comparator 625. In some embodiments, steps (a) and (b) may be implemented together by logically replacing input (for example, using a multiplexer, not shown) from the input buffer 432, with a constant len(C) on the input of XOR module 648. If there is an exact match at step (e), the authentication may be deemed successful, and data segment/cache line from the temporary buffer 445 may be passed to the rest of processor 150A. If there isn't an exact match, then it is an error and may be handled as described above for block 596 with respect to CCM.

GCM requires that the initialization vectors (IVs) be unique. Embodiments according to the present disclosure may satisfy the requirement by using the generated nonce as the high 96 bits of the IV. The nonce may be generated, for example, using the address ADDR as described with respect to CCM. As GCM authenticates IVs, this may also help to ensure that non-volatile storage blocks may not be swapped. Further, as described above, if all or portions of data doesn't need to be encrypted, some embodiments may use GCM AAD to authenticate data without encryption.

In some embodiments, if encryption is not required, message authentication codes (MACs), such as, for example, CBC-MAC, other Cipher-based MAC (e.g., One-key MAC (OMAC)), may be used. It should be noted that is CBC-MAC is used, it may rely on data segments being of the same length, which may offer a more simplified implementation. For all MAC schemas, it should be noted that the address ADDR may participate in creating MACs. For example, a fixed-length ADDR (or a fixed-length function using the ADDR as an input to generate a one-to-one output) may be pre-pended to the actual data segment for the purposes of calculating MAC. Using the address ADDR for MAC may ensure that an attacker cannot swap different data segments.

In other embodiments, if encryption is needed as well as authentication, then, for example, either Encrypt-then-MAC or MAC-then-Encrypt may be used. Further, to enable random access to encrypted data (which may require decryption at an arbitrary point), the counter (CTR) mode may be used for encryption. In these embodiments, the address ADDR may be added to the source material to be used to create MAC as described above. Also, the address ADDR may be used as a CTR counter during the encryption or decryption operations.

In some embodiments, variations of Encrypt-then-MAC may be used, combined with CBC mode. In this case, data may be encrypted in CBC mode as a whole, and then MAC may be calculated and stored for each data segment respectively. Then, the process of reading the encrypted data and authentication data may be as follows (again, assuming that block cipher is 128-bit long; for other block sizes, changes using known techniques may be necessary): a) read the encrypted 128-bit block PRE that immediately precedes the requested ADDR; b) read the encrypted data block DATA that corresponds to the requested address ADDR; c) read the MAC that corresponds to the requested address ADDR (note that in some embodiments, PRE, DATA, and MAC may represent a contiguous block in memory, which may speed up reading); d) check the validity of the MAC on DATA (if MAC is invalid—it is an error, which may be handled, for example, as described above at block 596 of FIG. 5); e) decrypt DATA, using PRE as an IV for decryption (in CBC, IV for the next block is encrypted data from the previous encrypted block). Combinations of CBC with Encrypt-and-MAC and MAC-then-encrypt may be built in a similar way.

In some embodiments, the secured data stored in the non-volatile storage according to embodiments of the present disclosure may need to be modified (updated, etc.) at a later time after manufacture. One way of accomplishing such modification is by storing the encryption keys in a secure database for later use by either the chip manufacturer (e.g., processor and/or the non-volatile storage manufacturer) or some trusted third party. Reusing the encryption keys, however, may cause security concerns because reuse of encryption keys may reduce the overall system security (e.g., by opening additional possibilities for differential cryptanalysis such as combining data segments from different versions of the code to obtain the effect desired for an attacker, as well as by potential exposure of the secure database). To ensure security, alternative mechanisms to update/revise the secured data in a protected non-volatile storage are described with respect to FIG. 8, FIG. 9A, and FIG. 9B below.

FIG. 8 is a block diagram of another exemplary system 100B according to the present disclosure. The exemplary system 100B may be a variation of the exemplary system 100A and may include the data interface 130, RAM 195 and non-volatile storage 192 just like the exemplary system 100A. In addition to those components that are the same as those of the exemplary system 100A, the exemplary system 100B may further comprise a processor 150B and a non-volatile storage programming module 190. The processor 150B may be an alternative embodiment of the processor 150A and may be capable of generating or updating content stored in the non-volatile storage 192.

Like the processor 150A of FIG. 1, the processor 150B may comprise one or more CPUs (e.g., CPU0 112 and CPU1 112A), one or more caches (e.g., L2 caches 114 and 114A, L3 cache 116) and a memory controller 160 that may comprise a key 165. In addition, the processor 150B may comprise a current symmetric key 170, a public key 172 (of a pair of asymmetric key pairs), a secure memory 174, an I/O port 175, an encryption module 176, a signature validation module 178 and a random number generator (RNG) 180. The RNG 180 may be any RNG such as, for example, a thermal-noise based or Zener noise-based generator, which may be used in support of generating encryption keys, and encryption and/or decryption operations. The secure memory 174 may be used in connection with operations of the signature validation module 178 and/or the encryption module 176. The data stored in the secure memory 174 may also be protected from access from outside the processor 150B. In one embodiment, such a secure memory 174 may, for example, be implemented as a separate volatile memory block inside the processor 150B.

In addition to using (e.g., decrypting and/or authenticating) data stored in the non-volatile storage 192, the processor 150B may also participate in generating and/or updating data to be stored in the non-volatile storage 192. It should be noted that the processor 150B may have a tamper resistant, or at least tamper evident physical enclosure similar to that of the processor 150A.

In one embodiment, the public key 172 may be a public key of a trusted party, which may be embedded into the processor 150B when the processor 150B is manufactured. This trusted party may be a manufacturer of the processor 150B or any other third party eligible to modify protected data stored in the non-volatile storage 192. In addition, the processor 150B may have the current symmetric key 170 permanently stored in an on-chip non-volatile memory. The current symmetric key 170 may be protected against access from outside the processor 150B. In one embodiment, access to the current symmetric key 170 may be restricted to certain components that are involved in generating the data (including encrypting data received from other sources) to be stored in the non-volatile storage 192 and decrypting the data read from the non-volatile storage 192 in subsequent reading of the data. The non-volatile programming module 190 may be coupled to the I/O port 175 to receive the secured data to be stored on the non-volatile storage 192. In an alternative embodiment, instead of the I/O port 175, the processor 150B may be coupled to the non-volatile storage 192 via direct memory access (DMA) controller (not shown).

The signature validation module 178 may be a module responsible for validating, using the public key 172, a signature of a trusted party (e.g., the processor manufacturer) providing data to be written to the non-volatile storage 192. The encryption module 176 may be capable of encrypting data with the current symmetric key 170. Both the signature validation module 178 and the encryption module 176 may be implemented in hardware, software, or a combination of hardware and software, and protected from modifications.

In one embodiment, the signature validation module 178 and encryption module 176 may be implemented as a separate circuit inside the processor 150B, and thus are protected from modifications by the physical enclosure of the processor 150B. For example, the validation module 178 and encryption module 176 may be implemented as one or more ASICs.

In another embodiment, the signature validation module 178 and encryption module 176 may be implemented as a set of instructions to be executed by a CPU of the processor 150B. In one software based embodiment, the instructions for the signature validation module 178 and encryption module 176 may be stored in a non-volatile storage (e.g., a ROM) (not shown) within the processor 150B and, thus, also protected from modifications by the physical enclosure of the processor 150B. In another software based embodiment, the instructions for the signature validation module 178 and encryption module 176 may be stored as secured data in an external non-volatile storage such as the non-volatile storage 192. If the instructions for the signature validation module 178 and encryption module 176 are stored as secured data in an external non-volatile storage (e.g., the non-volatile storage 192), in a manner similar to that described with respect to the embodiment of FIG. 1A, the memory controller 160 may store an encryption key (such as the encryption key 165) for decryption and/or authentication of the instructions for the signature validation module 178 and encryption module 176 when they are read into the processor 150B.

In embodiments in which the instructions for the signature validation module 178 and encryption module 176 are stored as secured data on an external non-volatile storage, the instructions may be non-updateable or updateable. In an embodiment with non-updateable instructions, the processor 150B may have both the keys 170 and 165 stored therein. The key 165 may be used decrypt and/or authenticate the non-updateable instructions while the key 170 may be used to decrypt and/or authenticate other secured data stored on the external non-volatile storage (after the other secured data is encrypted/authenticated using the key 170).

In an embodiment in which the instructions for the signature validation module and encryption module are updateable, the processor 150B may use the same key for both key 165 and current symmetric key 170 (in some embodiments only one copy of this key may be stored). These keys may be replaced each time an update process is performed (as described in more detail below)

Regardless of whether the instructions for the signature validation module 178 and encryption module 176 are implemented as specialized hardware inside the processor 150B, stored on a non-volatile storage in the processor 150B and executed by a CPU of the processor 150B, or stored as secured data on an external non-volatile storage and executed by a CPU of the processor 150B, in one embodiment the processor 150B may always have a key (e.g., keys 165, 170, or both) stored therein, and the exemplary processes 200, 500 and 700 may be performed using the processor 150B.

As described above, the processor 150B may receive data from a trusted party to be written into the non-volatile storage 192. The data may be accompanied by a signature, which may be verified by the signature validation module 178 using the public key 172. If the signature verification is successful, in one embodiment, the data may be encrypted by the encryption module 176. In other embodiments, authentication information may be attached to the data but the data itself may not be encrypted. In either cases, the processed data (e.g., secured data) may be transmitted to the non-volatile programming module 190, which may send the encrypted data to the non-volatile storage 192.

FIG. 9A shows an exemplary process 800 which illustrates how the secured data stored in a non-volatile storage may be updated in a secure manner. The following description of the exemplary process 800 may use the system 100B as an example but may be applicable to other embodiments according to the present disclosure.

At block 805, data to be stored in the non-volatile storage 192 may be received by the processor 150B. The received data may be signed by a legitimate party with a private key that may correspond to the public key 172. At block 810, the processor 150B may verify the signature using public key 172 and signature validation module 178. The signature validation may optionally include validity checking mechanism such as, certificate revocation list (CRL) and/or Online Certificate Status Protocol (OSCP). If the signature validation fails, then, at block 812, the process 800 may be aborted, and no changes to the system may be done.

In some embodiments, some of the modules required for the update (for example, the signature validation module 178 or encryption module 176) may be implemented in software, and the instructions for any of such modules may be stored as secured data on an external non-volatile storage (as described above) and may be updateable. In these embodiments, additional measures may need to be taken to address inconsistent state. For example, in one embodiment, there may be two copies of the non-volatile storage 192 and a non-volatile flag to indicate which of the two copies is currently “active” (being read by a memory controller). When updating the non-volatile storage in this embodiment, the write operation may be performed on the “inactive” copy; and when the update is completed, the non-volatile flag may be switched to indicate the previously “inactive” copy as “active.” In this embodiment, even if the update process has been interrupted, the system will be able to read an “old” version of the instructions for those modules involved in the update process, and to repeat the update process to write “new” version of the secured data.

If the signature validation is passed successfully, then, at block 815, using the RNG 180, a new current symmetric key may be generated and stored temporarily (for example, in the secure memory 174). At block 820, the processor 150B may encrypt the received data using encryption engine 176 and the new current symmetric key generated at block 815, and at block 825, the encrypted data may be stored in the non-volatile storage 192 via the I/O port 175. After successfully updating the non-volatile storage 192, at block 830, the new current symmetric key generated at block 815 may be stored permanently as the current symmetric key 170. Once stored permanently inside the processor 150B, the current symmetric key 170 may be used to read data stored in the non-volatile storage 192.

If an error occurs during the blocks 805-830, the system may be in an inconsistent state. For example, an error may occur due to power failure, such that only part of the data may have been updated, or all data is updated but a key generated at the block 815 has not been saved permanently, or other errors. In all such cases, blocks 810 through 830 may be repeated with the data received at block 805 (e.g., assuming the data received at block 805 is stored in a non-volatile storage of the processor 150B.

In order to reduce the risk of a possible known-plain-text attack, the data encrypted with an encryption key generated at block 815 may be protected against being exposed to the outside of the processor 150B before validation of that data. In a non-limiting embodiment, the amount of secure memory 174 may be less than necessary for processing the update all together. Even in this case, the complete set of data to be updated may be verified and encrypted in chunks and every single chunk may only be exposed in the encrypted form outside the processor chip 150B. Regardless the size of the secure memory 174, however, the update may be divided by chunks and processed as described below.

FIG. 9B is a block diagram showing exemplary data structures for performing an update to a non-volatile storage according to the present disclosure. As shown in FIG. 9B, an update 840 may comprise one or more data chunks 841 (e.g., 841-1 through 841-n with n being a positive integer) and a terminating chunk 842. Each data chunk 841 may include an update ID 845, chunk data 846, chunk address 847, chunk hash 848, and chunk signature 849. The chunk address 847 may represent an address within the update 840. The chunk signature 849 may be created with a private key that may correspond to the public key 172 in a public/private key pair. The value of the update ID 845 in all chunks of one update 840 may be the same, and chunk addresses 847 for all chunks of one update 840 may form a sequence in which all chunks within the update 840 may follow. Chunk data 846 may be the actual data that needs to be updated and, optionally, its size may be a multiple of the size of the cache line (typically, 64 bytes). The terminating chunk 842 may include at least the hash 844 of the whole update and chunk signature 849 to verify the integrity of the whole update.

FIG. 9C illustrates an exemplary process 850 of applying an update consisting of more than a single chunk to a non-volatile storage according to the present disclosure. At block 860, the processor chip 150B may receive information that an update for the non-volatile storage 192 is available. Such information may, for example, include an ID of this update (such as the update ID 845). At block 862, the processor 150B may temporarily save this ID. At block 864, using the RNG 180, a new current symmetric key (e.g., the key 170) may be generated and stored temporarily (for instance, in the secure memory 174).

At block 865, the processor chip 150B may receive a data chunk 841. Then at block 866, the processor chip 150B may perform a verification to make sure the data chunk 841 is a valid chunk. In one non-limiting embodiment, the verification may include checking that the hash is correct, the signature is done using a private key that corresponds to a public key 172, its update ID 845 corresponds to that saved at step 862, and that its address is in sequence (e.g., with respect to a preceding chunk if available). If this verification fails, then, at block 867, the process 850 may be aborted, and no further changes to the system are done. Thus, no chunk data, even in encrypted form, may be exposed outside the chip 150B.

Otherwise, if all verifications at block 866 are passed successfully, then, at block 870 the processor chip 150B may incrementally calculate a hash of already processed data of the whole update. Then at block 872, the processor chip 150B may encrypt the chunk data 846 using the new current symmetric key generated at step 864, and at block 875, may send the encrypted data to be stored in the non-volatile storage 192.

At block 880, the process 850 may determine whether all data chunks for the update have been received. For example, the process 850 repeat blocks 865 through 875 until the terminating chunk 842 is found. At block 882, once the terminating chunk 842 is received, the processor chip 150B may also verify the terminating chunk is valid, for example, by checking the signature of the terminating chunk 842, and that the incrementally computed (by repeating the block 870 with all previous chunks) hash of the whole update data is equal to that stored in the terminating chunk as the hash 844.

If the check at block 882 fails, at block 883, the process 850 may be aborted. For example, an error may be reported and no further changes to the system are performed. If the check is passed, then, at block 885, the encryption key generated at block 864 may be stored permanently as the current symmetric key 170. At this point, the system may be in a consistent state, and the new current symmetric key 170 may be used to read data stored in the non-volatile storage 192.

While specific embodiments and applications of the present invention have been illustrated and described, it is to be understood that the invention is not limited to the precise configuration and components disclosed herein. The terms, descriptions and figures used herein are set forth by way of illustration only and are not meant as limitations. Various modifications, changes, and variations which will be apparent to those skilled in the art may be made in the arrangement, operation, and details of the apparatuses, methods and systems of the present invention disclosed herein without departing from the spirit and scope of the invention. By way of non-limiting example, it will be understood that the block diagrams included herein are intended to show a selected subset of the components of each apparatus and system, and each pictured apparatus and system may include other components which are not shown on the drawings. Additionally, those with ordinary skill in the art will recognize that certain steps and functionalities described herein may be omitted or re-ordered without detracting from the scope or performance of the embodiments described herein.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of microprocessors, microcontrollers, field programmable gate arrays (FPGAs), application specific integrated circuits (ASICs), and/or System on a Chip (SoC)—but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

What is claimed is:

1. A computer processor, comprising:
a central processing unit (CPU); and
a memory controller, comprising:
a storage to store a key;
a first set of circuitry configured to:
receive a request for a piece of data from the CPU;
determine that the requested piece of data needs to be read from an external storage stored in a secured format; and
read the piece of data from the external storage in the secured format; and
a security module configured to perform at least one of authentication and decryption on the piece of data in the secured format using the key stored in the storage.

2. The computer processor of claim 1, wherein to determine that the piece of data need to be read from the external storage comprises to calculate an address for the piece of data based on an original address in the request for the piece of data.

3. The computer processor of claim 1, wherein the secured format is authentication without encryption, and the security module is configured to perform authentication.

4. The computer processor of claim 3, wherein the security module is configured to implement authentication by cipher block chaining message authentication code (CBC-MAC).

5. The computer processor of claim 1, wherein the secured format is encryption without authentication, and the security module is configured to perform encryption.

6. The computer processor of claim 1, wherein the secured format is authentication and encryption, and the security module is configured to perform both authentication and encryption.

7. The computer processor of claim 6, wherein the security module is configured to implement authentication and encryption by Authenticated Encryption with Associate Data (AEAD) algorithm.

8. The computer processor of claim 7, wherein the security module is further configured to derive a nonce to be used to perform the AEAD algorithm from an address of the piece of data requested.

9. The computer processor of claim 7, wherein the AEAD algorithm is one of: Counter with cipher block chaining message authentication code (CBC-MAC) (CCM) authenticated encryption algorithm, EAX mode, and Galois/Counter Mode (GCM).

10. The computer processor of claim 9, wherein the security module is further configured to derive a nonce to be used to perform the AEAD algorithm from an address of the piece of data requested.

11. The computer processor of claim 1, further comprising:
a second set of circuitry configured to:
receive a new piece of data to be stored in the external storage, the new piece of data being signed with a signature; and
generate and store a new encryption key;
a signature validation module configured to verify the signature; and
an encryption module is configured to, using the new encryption key, process the new piece of data into the secured format to be sent to the external storage.

12. The computer processor of claim 11, further comprising a storage for storing a public key of a trusted party and the signature validation module is further configured to use this public key to verify the signature of the new piece of data.

13. The computer processor of claim 12, wherein the new piece of data is an update to the piece of data stored in the external storage.

14. The computer processor of claim 13, wherein the processed new piece of data comprises one or more data chunks and a terminating chunk.

15. The computer processor of claim 14, wherein each data chunk includes a hash value for chunk data of the data chunk and the terminating chunk includes a hash value for the new piece of data as a whole, and each data chunk and the terminating chunk includes a chunk signature respectively.

16. The computer processor of claim 11, wherein to process the new piece of data into the secured format comprises encrypting the new piece of data.

17. The computer processor of claim 11, wherein to process the new piece of data into the secured format comprises generating authentication data for the new piece of data.

18. The computer processor of claim 11, wherein to process the new piece of data into the secured format comprises encrypting the new piece of data and generating authentication data for the new piece of data.

19. A method for accessing data stored securely external of a computer processor, comprising:
receiving a request for a piece of data from a central processing unit (CPU) of the computer processor;
determining that the requested piece of data needs to be read from an external storage stored in a secured format;
reading the piece of data from the external storage in the secured format; and
performing at least one of authentication and decryption on the piece of data in the secured format using a key stored in the computer processor.

20. The method of claim 19, wherein determining that the piece of data need to be read from the external storage comprises calculating an address for the piece of data based on an original address in the request for the piece of data.

21. The method of claim 19, wherein the secured format is authentication without encryption, and the computer processor comprises a security module configured to perform authentication.

22. The method of claim 21, wherein the security module is configured to implement authentication by cipher block chaining message authentication code (CBC-MAC).

23. The method of claim 19, wherein the secured format is encryption without authentication, and the computer processor comprises a security module configured to perform encryption.

24. The method of claim 19, wherein the secured format is authentication and encryption, and the computer processor comprises a security module configured to perform both authentication and encryption.

25. The method of claim 24, wherein the security module is configured to implement authentication and encryption by Authenticated Encryption with Associate Data (AEAD) algorithm.

26. The method of claim 25, further comprising deriving a nonce to be used to perform the AEAD algorithm from an address of the piece of data requested.

27. The method of claim 25, wherein the AEAD algorithm is one of: Counter with cipher block chaining message authentication code (CBC-MAC) (CCM) authenticated encryption algorithm, EAX mode, and Galois/Counter Mode (GCM).

28. The method of claim 27, further comprising deriving a nonce to be used to perform the AEAD algorithm from an address of the piece of data requested.

29. The method of claim 19, further comprising:
receiving a new piece of data to be stored in the external storage, the new piece of data being signed with a signature;
generating and storing a new encryption key;
verifying the signature; and
processing the new piece of data, using the new encryption key, into the secured format to be sent to the external storage.

30. The method of claim 29, further comprising
verifying the signature of the new piece of data using a public key of a trusted party stored in the computer processor.

31. The method of claim 30, wherein the new piece of data is an update to the piece of data stored in the external storage.

32. The method of claim 31, wherein the processed new piece of data comprises one or more data chunks and a terminating chunk.

33. The method of claim 32, wherein each data chunk includes a hash value for chunk data of the data chunk and the terminating chunk includes a hash value for the new piece of data as a whole, and each data chunk and the terminating chunk includes a chunk signature respectively.

34. The method of claim 29, wherein processing the new piece of data into the secured format comprises encrypting the new piece of data.

35. The method of claim 29, wherein processing the new piece of data into the secured format comprises generating authentication data for the new piece of data.

36. The method of claim 29, wherein processing the new piece of data into the secured format comprises encrypting the new piece of data and generating authentication data for the new piece of data.
